(19) United States
(12) Patent Application Publication
(10) Pub. No.: US 2021/0262443 A1
(43) Pub. Date: Aug. 26, 2021

(54) Dual-Hybrid Solar and Wind-enabled Triple-Helical Shaped Savonius and Darrieus-type Vertical Axis Wind Turbine (VAWT)

(71) Applicants: Joel C. GOLDBLATT, Angel Fire, NM (US); Larry MAPES, Taos, NM (US); John CRONIN, Golden, CO (US); Kaushik MALLICK, Golden, CO (US); Mickey SILVA, Golden, CO (US); Mike STEWART, Golden, CO (US); Josh VARN, Golden, CO (US); Massimo TORRI, Calgary (CA); Jill SABLOSKY, Philadelphia, PA (US); Bluenergy Solarwind, Inc., Angel Fire, NM (US)

(72) Inventors: Joel C. Goldblatt, Angel Fire, NM (US); Larry Mapes, Taos, NM (US); John Cronin, Golden, CO (US); Kaushik Mallick, Golden, CO (US); Mike Stewart, Golden, CO (US); Mickey Silva, Golden, CO (US); Josh Varn, Golden, CO (US); Massimo Torri, Calgary (CA); Jill Sablosky, Philadelphia, PA (US)

(21) Appl. No.: 17/253,916

(22) PCT Filed: Jun. 18, 2019
(86) PCT No.: PCT/US19/37798

§ 371 Date: Dec. 18, 2020

Related U.S. Application Data
(60) Provisional application No. 62/686,478, filed on Jun. 18, 2018.

(51) Int. Cl. F03D 9/00; F03D 9/11; F03D 3/00; F03D 3/06; F03D 15/00

(52) U.S. Cl. CPC F03D 9/007; F03D 9/11; F03D 3/005; F03D 3/061; F03D 15/00; F05B 2240/61; F05B 2240/213; F05B 2240/212; F05B 2250/25; F05B 2260/90; F05B 2220/708

(57) ABSTRACT

A hybrid solar/wind turbine apparatus, which includes a blade and shelf assembly configured to provide wind impulsion and wind capture. The blade and shelf assembly are located between an upper and a lower platform assembly. The blade assembly is helically disposed about an axis, for generating torque. A transmission shaft is in communication with the blade assembly and configured to receive the generated torque. One or more photovoltaic cells are in communication with the blade assembly for photovoltaic energy generation, either alone or in combination, with the torque. A means to integrate and combine the photovoltaic energy generating photovoltaic cells into the wind capturing blade assembly.

### FIELD OF THE INVENTION

The present invention relates generally to a uniquely designed helically-shaped, hybrid design of a Savonius-type (drag-type) and Darrieus (lift-type) vertical axis wind turbine (VAWT) that utilizes small-wind generation technology together with integrated solar photovoltaic electric technology, for combined electricity production to create a clean, renewable energy source. More specifically the present invention is directed to a multi-component and multi-functional apparatus capable of creating an “open source” power supply, via conversion of natural energy sources (e.g. sun and wind), that is designed for on-site urban, suburban or rural placement which evidences a flexible off-grid/on-grid, smart-grid or microgrid funding capability at or near the point of use. This eliminates the use of, or need for, any utility-provided transmission or distribution lines. Further the present invention is quiet, visually pleasing, scalable up or scalable down in number and adjustable in size and capacity thus adding to the present invention's overall versatility. The Savonius-type and Darrius (lift-type) vertical axis wind turbine (VAWT) may act independently of the utility grid (off-grid), in combination with or integrateably fed into the existing power grid structure (on-grid).

### DESCRIPTION OF THE RELATED ART

The derivation of power through the conversion of kinetic (wind) energy into mechanical/electrical energy is a concept that has been used throughout history—first as a “panemone windmill” itself a “Vertical Axis Wind Turbine” consisting of wind sails horizontally adhered to a vertical, centrally disposed shaft for the pumping of water and milling of grain. Although, overall lacking in efficiency, the “panemone windmill” and “panemone-type” vertical windmills are nonetheless an aesthetically attractive design that has been visited and revisited numerous times by several inventors (See generally U.S. Pat. Nos. 4,142,822, 4,260,325, and 7,677,862).

Indeed, Vertical Axis Wind Turbines (VAWTs) are a sophisticated adaptation on the more traditional Horizontal Axis Wind Turbine (HAWT) which has been, to date, the most commonly employed means of generating wind derived power. Primarily, while the blades of the Horizontal Axis Wind Turbine move at right angles to the force of the wind (using lift as the primary means of blade movement), VAWTs move parallel to the wind, using drag as the primary means of motion creation thereby rotating a vertical axis. Yet, implementation of HAWTs have several disadvantages including (1) placement of the main rotor shaft and electrical generation on top of the tower up high and away from accessible repair and maintenance, (2) a requirement that the turbine be directed into the wind, (3) and wear due to inertial forces and gravity where blades experience alternating loads dependent upon the position of the blade at different stages of the rotational cycle and the increased stress and wear that those vacillating forces bring to bear.

In opposite, the overall configuration of the VAWT, and its vertical arrangement, lends itself to a more useful implementation where (1) VAWT's simplified structure harbors the ability to receive wind from multiple directions obviating the need for a steering device and the (2) harboring of a rotor assembly and generator that is at the base of the assembly (affording a lower center of gravity and increased stability and ease of accessibility for repair and maintenance), (3) the VAWT is not limited to wind direction and does not have to be positioned in the direction of the wind (an advantage in areas with multidirectional wind or variant wind changes) and (4) the consistent inertial and gravitational forces that do not fluctuate therefore lending themselves to less fatigue and reciprocal increased operational longevity. Furthermore, VAWTs display a larger power generation efficiency, exhibit a smaller rotational blade space, evidence a larger wind resistance capability (at nominal, turbulent and dynamic wind speeds), with fewer environmental and ecological impacts (i.e. lower noise dB generation and no harmful effects on birds via intentional design features, compactness and lower average rotational speeds), reduced sensory impacts (e.g. sound/noise production/pollution, negative visual distractions, and “shadow flicker”) and the ability of VAWTs to begin their rotation cycle slowly and smoothly with low wind speed up to and including wind speeds in excess of a traditional HAWTs—all leading to an creased applicability and use across a number of acceptable spaces: urban, suburban, rural, commercial, residential, and cross over areas and dual-purpose areas alike. Conversely, impact of environment factors (contamination and corrosion) on the turbine and its principal functional components (i.e. turbine blades) can be seen to more adversely affect the aerodynamics of HAWTs due to their turbine blade exposure and design than is experienced by conventional VAWTs (See generally W. Han, J. Kim, B. Kim. Effects of contamination and erosion at the leading edge of blade tip air fails on the annual energy production of wind turbines. Renewable Energy 115 (September 2017) 817-823.

In addition to strides in the wind power generation field, attempts have as well been made to address the combination of wind and solar power through co-locating collection sources—all with varying degrees of success in terms of both implementation and efficiency. U.S. Pat. No. 5,254,876, issued to Hickey, discloses a HAWT exhibiting a “plurality of light sensitive cells” (abstract) as a secondary source of energy collection, in addition to the chief source (i.e. wind), where the system incorporates said cells on the surface of the rotationally active spirally shaped air vanes (blades) and performs a dual-function of environmentally sourced energy collection through both light and wind. Yet, the wind powered generator is of a horizontal configuration, and thus subject to the resultant infirmities described above, while each blade exhibits solar cells equally in a horizonal position obviating more efficient, vertically oriented reception of light of the present invention.

U.S. Pat. No. 4,119,863 discloses a VAWT with a closely combined “high density” and “open framework” wherein photovoltaic panel collectors and “vertical wind turbines” are integrated in an intricately configured, complicated system that intimately combines several functionally active and moveable features into lattice structure that is more compact than that of Hickey, but suffers from inefficiency of design and complexities that promote a vastly less desirable configuration.

No less complex or inefficient attempts have been formulated to combine wind and solar energy capture by Cifaldi (U.S. Pat. No. 6,372,978), Buels (U.S. Pat. No. 4,471,612), Baer (U.S. Pat. Application No. 2010/0294265), Manolis (US Pat. Application No. 2003/0160454) or Yang (U.S. Pat. Application No. 2009/0237918).

It is therefore a goal of the present invention to provide a system that combines solar and wind energy into one seamlessly cohesive assemblage for the creation of both mechanical and electrical energy through naturally occurring renewable energy sources.

Essentially, the present invention allows for collection and conversion of solar, and solar derived wind energy combined to provide a more complete and independently operable solution to targeted clean power generation.

There remains a significant, well-recognized, and unmet need in the art for inventions, methods and integrated “clean energy” systems, that provide for varied forms of energy harnessing and conversion, via a diverse and interrelateable collection methods and modalities, to achieve an “open source” power supply that fits the needs of individuals, communities and entire populations alike through environmentally conscious, efficient and scalable renewable energy production. The present invention satisfies this long-standing need in the art.

### SUMMARY OF THE INVENTION

The present invention utilizes a curved 3-blade, helical geometry N-blade Savonious-type vertical axis wind turbine (VAWT) that utilizes captured wind (via curved “air foils” “curved blades”) to create a force (i.e. torque) which is transferred to a vertically-positioned, centrally disposed shaft and ultimately to an electrical generator for the production of electricity. Additionally, the present invention consists of angled solar power cells (relying on photovoltaics and photochemistry) positioned about the base of the invention which are responsible for additional electrical energy production—either direct, stored, or consisting of a hybridization, alone or in combination—together with generated wind energy.

The turbine assembly that is the present invention consists of a stacked, modular 3-blade section assemblies in the form of a Savonius-type triple blade rotor stacked atop one another into 4 sections wherein each curved blade body is oriented vertically in parallel with a rotationally operable shaft. Each semi-circular, helically configured blade body exhibits a concave arc (i.e. airfoil) for the capture of fluid (i.e. wind) energy for the potentiation of vertical axis rotation in this primarily drag-type device—although several advantageous of the Darrieus-type VAWT are also incorporated to achieve enhanced efficiency and power generation. The blades themselves are attached to one another in a relatively seamless configuration where the base of one blade body integrates into the top of the next adjoining blade body, horizontally, creating an exteriorly running, vertical vane that “snakes” across the exterior perimeter in a spiral manner resembling a coil spring' or “corkscrew”. Each cross-sectional junction (between each modular blade section assembly) consists of a “hub and spoke” configuration wherein each “spoke” of the Savonius triple blade rotor resembles a half “S” curving from the “hub” and projecting outwardly in a direction opposite the fluid flow as to capture translocating fluid. Further, both the top of the turbine assembly and bottom of the turbine assembly are “capped” and “floored” horizontal to the body bodies and rotational axis by disc plates, a set of three integrated components forming a flat, planar surface, as to disallow the escape of fluid and thus further synergize with the energy garnering actions of the blades.

The unique design and configuration of the hybrid solar/wind turbine utilizes a. means to integrate and combine photovoltaic energy harnessing technology seamlessly into the wind capturing capabilities of a modular 3-blade, helical geometry N-blade Savonious-type vertical axis wind turbine (VAWT) for the production of both wind and solar-derived electrical power. Specifically, the present invention provides the integration of experimentally developed, technology and laboriously examined design elements featuring tested efficiencies (through countless prototype permutations, modifications and realized improvements) to lead to the explicit (and disclosed) design that utilizes several unique and innovative improvements for renewable energy acquisition: (1) a light, durable blade and assembly material that is (2) contoured in such a manner as to provide maximum wind impulsion, with (3) optimum wind capture through “capped” and “floored” top and bottom platform assemblies together with the added benefit of (4) photovoltaic energy generation. Additionally, it is the modular construction of the present invention that provides an economic incentive and benefits (separable and modular blade development being financially preferable to costly and materials wasting whole piece constructions, heightened blade integrity through more uniform weight distribution via load bearing shelf assemblies and a load-receiving bottom platform assembly, and detachably replaceable blade constructs. Moreover, the modular design of the present invention facilitates an ease of assembling and disassembly that is a hallmark of the method by which the hybrid turbine can be manufactured, placed and replaced.

It is an objective of the inventors to integrate wind and solar energy into a single platform, each capable of working independently as well as in combination, and then also to assimilate the present invention into a single source/multi-source energy desegregation, where the present invention is equally capable of stand-alone and group operations in conjunction with other 3-blade, helical geometry N-blade Savonious-type vertical axis wind turbines/solar assemblies and/or assimilated into an entire grid of “like-operating” solar, wind or water energy generating devices. It is yet another objective of inventors to establish a comprehensive, integrated communication among and across several similar and dissimilar apparatuses into organized systems of harvesting environmentally derived resources in a cost effective and aesthetic manner creating stakeholder value while stimulating personal and local economies in an environmentally responsible way.

What is more specific to the points above, the present invention can be utilized to create a renewably generated and distributable power source for commercial, residential and mixed-use areas for any number of energy requirements including, but not limited to: personal consumer use, business use, back-up power generation, load sharing, resale to power companies, energy engineering projects, remote location energy generation, economically underserved areas, project and construction development and management, and compatible, standard integration into existing (conventional) gas, coal and natural gas supplies.

And while the dimensions may vary, it is to be understood that slight modifications to the overall perimeters and specifications of the invention may be undertaken without deviating from the overall scope and spirit of the invention. Manifestly, although inventor has disclosed the preferred means of design and use, the device may be scalable according to conditions and desired wind capture, rotational speed and energy requirements to employ modifications in terms of numbers of modular sections, numbers of blades, length of blades and overall height and size of the present device.

### BRIEF DESCRIPTION OF THE DRAWINGS

Advantages and other aspects of the invention will be readily appreciated by those of skill in the art and better understood with further reference to the accompanying drawings in which like reference characters designate like or similar elements throughout the several figures of the drawings and wherein:

FIG. 1 depicts a 3-blade, helical geometry N-blade Savonious-type vertical axis wind turbine (VAWT) with installed photovoltaic (PV) panels.

FIG. 2 depicts a perspective, disassembled view of the four individual modular sections of the turbine assembly and hub and spoke joinders complete with top and bottom platform assemblies.

FIG. 3 depicts a turbine platform assembly with integration plate.

FIG. 4 discloses a lower platform assembly that has been inverted.

FIG. 5 depicts turbine platform construct.

FIG. 6 illustrates individual blade braces “spoke and hub” assemblages for assembly.

FIG. 7 shows hub-spoke-blade assembly assembled and attached to blades.

FIG. 8 illustrates two of the blade sections on a “hub and spoke” shelf assembly.

FIG. 9 is the completed shelf assembly.

FIG. 10 depicts the transmission shaft configuration and support of the present invention.

FIG. 11 the lower shall assembly, locking device and central shaft assembly

FIG. 12 shows the completed turbine base structure.

FIG. 13 illustrates a wind turbine, shaft and solar panel base.

FIG. 14 is a schematic depicting power generation, power storage and output to the grid.

FIG. 15 shows mechanical energy input via the turbine, power receiving generator and control generator/brake.

FIG. 16 evidences a complete system schematic.

FIG. 17 is a top view of the present invention.

FIG. 18 evidences a smart system where the present invention evidences a “smart software” function called “WiseEnergy®” that allows to user to monitor and control energy input, energy output, energy consumption and energy deployment to the grid.

FIG. 19 is a weldment structure showing lower, mid and upper weldments.

### DETAILED DESCRIPTION

A detailed description of the preferred embodiments of the invention is disclosed and described below. Yet, each and every possible dimension and arrangement, within the limits of the specification, are not disclosed as various permutations are postulated to be in the purview and contemplation of those having skill in the art. It is therefore possible for those having skill in the art to practice the disclosed invention while observing that certain features and spatial arrangements are relative and capable of being modified, arranged and rearranged at various points about the present invention that nonetheless accomplishes the remediation of one or more of the infirmities as outlined and discussed above in the field of solar and wind power procurement.

Equally, it should be observed that the present invention can be understood, in terms of both structure and function, from the accompanying disclosure and claims taken in context with the associated drawings. And whereas the present invention and method of use are capable of several different embodiments, which can be arranged and rearranged into several configurations, each may exhibit accompanying interchangeable functionalities without departing from the scope and spirit of the present application as shown and described.

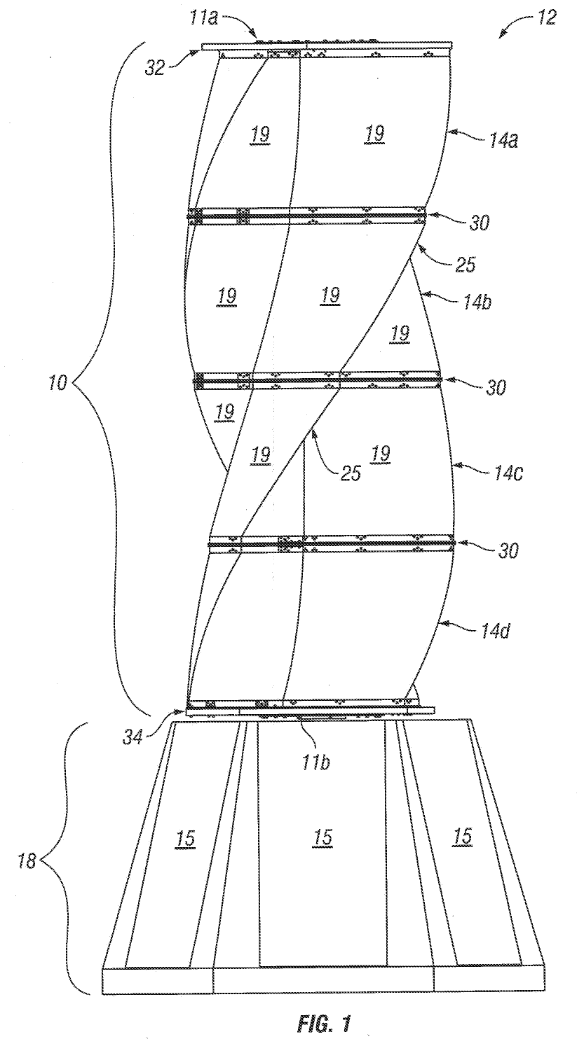

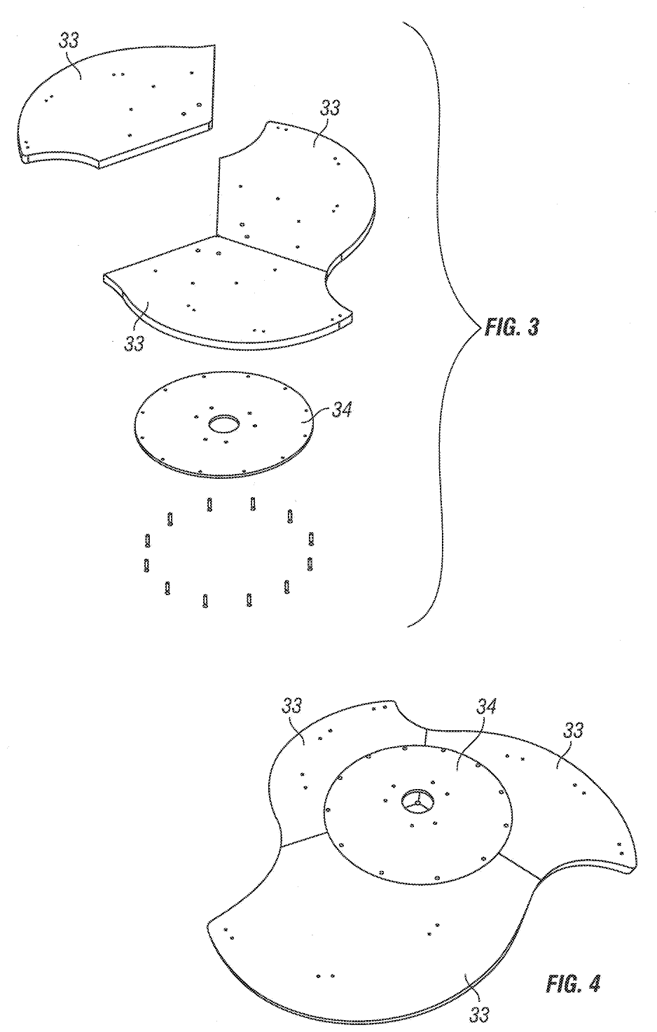

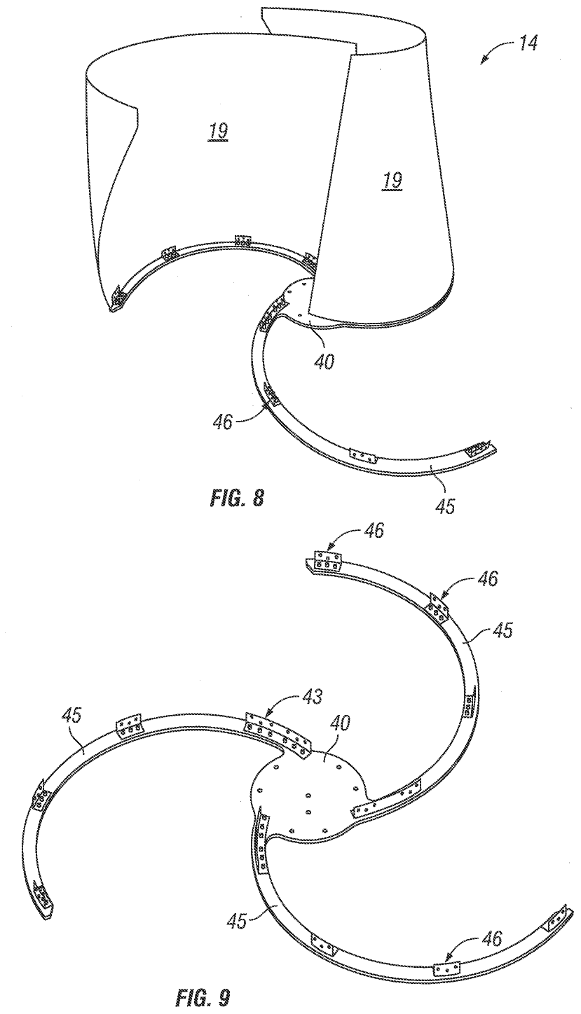

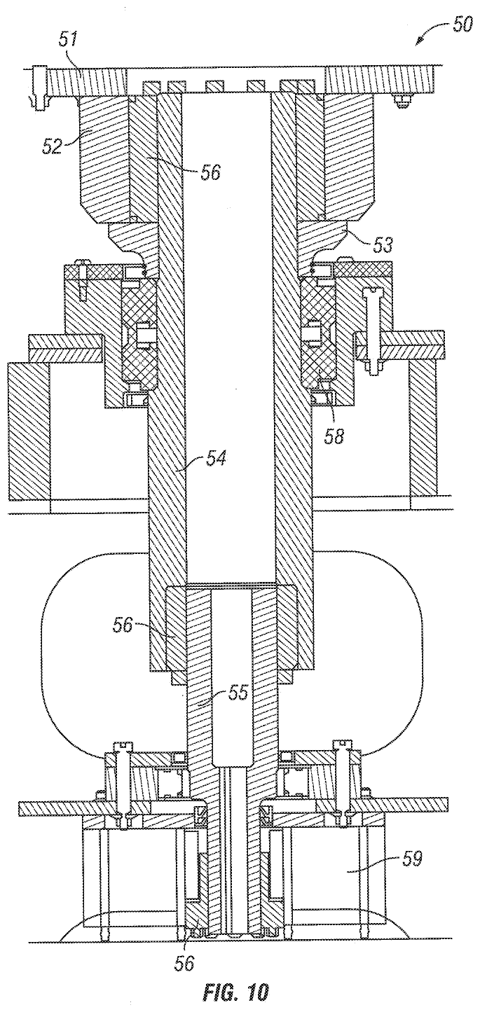

As detailed in FIGS. 1, 2, 6-10 and 13, the helically-shaped, hybrid design of a Savonius-type (drag-type) and Darrieus (lift-type) vertical axis wind turbine (VAWT) that is the present invention consisting of a turbine 10 and photovoltaic assembly 12 wherein a stacked, modular 3-blade section assembly 14 in the form of a Savonius-type triple blade rotor stacked atop one another into 4 sections, 14a, 14b, 14e and 14d, from top to bottom, wherein each curved blade body 19 is oriented vertically in parallel with a rotationally operable shaft 50 (depicted in FIG. 10). Each semi-circular, helically configured blade body 19 exhibits a concave arc (i.e. airfoil) for the capture of fluid (i.e. wind) energy for the potentiation of vertical axis rotation in this primarily drag-type device—although several advantages of the Darrieus-type VAWT are also incorporated to achieve enhanced efficiency and power generation. The turbine blade bodies 19 themselves are attached to one another in a relatively seamless configuration where the base 19b of one blade body integrates into the top 19a of the next adjoining blade body, horizontally, creating three exteriorly running, vertical vanes 25 that “snake” across the exterior perimeter in a spiral manner resembling a “coil spring” or “corkscrew”. Each cross-sectional junction 30 (between each modular blade section assembly 14) consists of a “hub and spoke” assemblage 39 configuration wherein a hub 40 is centrally deposed and aligned with the rotational operational shaft 50 vertically wherein each spoke 45 of the Savonius triple blade rotor resembles a half “S” curving from the hub 40 and projecting outwardly in a direction opposite the fluid flow as to capture translocating fluid. Each hub 40 and spoke 45 evidenced in FIG. 6 disassembled, FIG. 6 partially assembled and FIGS. 8-9 assembled. Further, both the top of the turbine assembly 11a and bottom of the turbine assembly 11b are “capped” and “floored” horizontal to the blade bodies and rotational axis by disc plates in the form of a segmented turbine cap plate 32 and a turbine platform 34 comprising a set of three integrated components 33 forming a flat, planar surface, and adhered together via integration plate 34 (see FIGS. 3-4) as to disallow the escape of fluid at both top 11a and bottom 11b of the VAWT turbine assembly 12 and thus further synergizing with the energy garnering actions of the blades 19. Lower turbine cap plate and support platform 35, too, serves to support the entire turbine assemblies' weight as well as facilitates the turbine assembly's fluid movement.

### Dimensions

### Height

The complete VAWT assembly and invention 12 (including turbine 10 plus axially applied Photovoltaic (PV) panels 15 to the inwardly planning base 18) as illustrated in FIGS. 1 and 13 is 7.62 m (25 ft) high from bottom of the primary structure to the top of the turbine and weighs approximately 1,995.8 kg (4,400 pounds). The turbine 10 portion is constructed of vertically arranged 3-blade section assemblies stacked 4 sections high, with a turbine cap plate 32 on the top and turbine platform 34 on the bottom, with a total height of the rotational component of the turbine assembly 12 measuring approximately 5.38 meters (17 feet 8 inches) with a weight of 544 kg (1,200 pounds). The inwardly planning base measures 2.18 meters (7 feet 2 inches)

### Assembly

### Blade Section and Hub and Spoke Assemblies

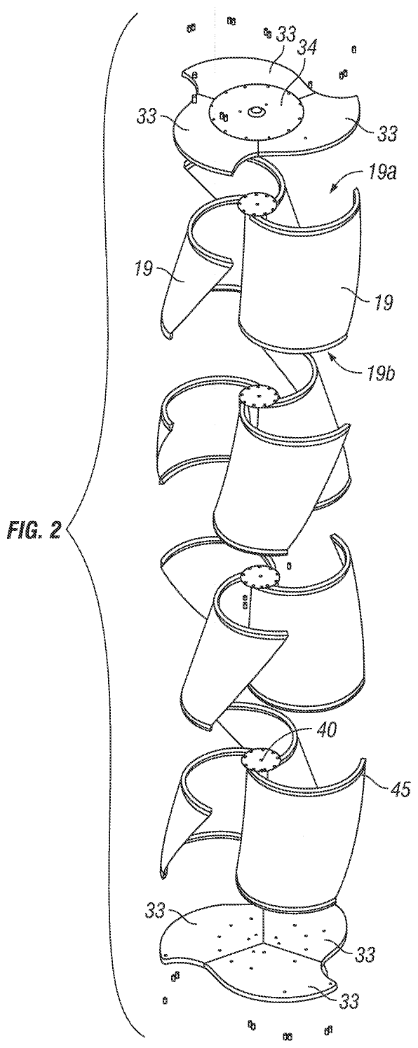

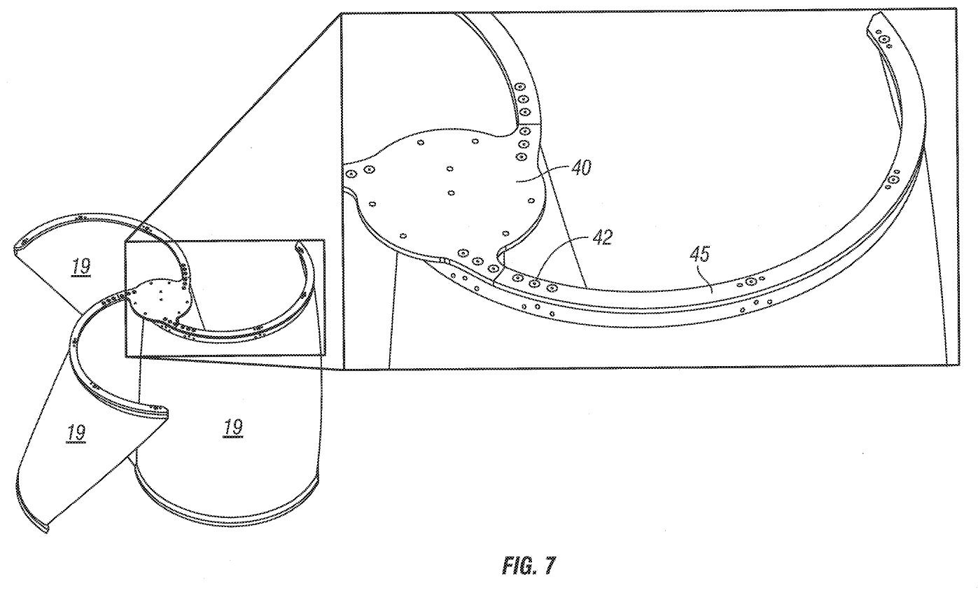

As illustrated in FIGS. 2-4 and 7 and 8-9, each blade section assembly 14 consist of 3 uniformly equal glass fiber composite blades 14 installed between two shelf assemblies 30 with aluminum fastening components Shown in FIGS. 8 and 9). Where FIG. 7 displays an inverted blade section assembly 14 where rivets 42 serve the function of attachment of the “hub and spoke” assemblage 39 (provided upright in FIG. 9) where hub 40 is connected to spoke 45 via coupling angle bracket 43. In addition, adherence of each turbine blade body 19 to each “hub and spoke” assemblage 39 via small angle brackets 46. A total of 4 blade sections are stacked, positioned and fastened to one another in a hub 40 and spoke 45 configuration for ease of replaceability and simplicity of assembly. The hub 40 and spoke 45 configuration is additionally segregated into individual parts to avoid the significant excess material waste of a single piece of aluminum. The components of these hub 40 and spoke 45 assemblies are cut from formed angle extrusion and aluminum plates that are then milled to the final drawing specification cut from 0.5-inch aluminum plating. The turbine blade bodies 19 are curved to a specific radius of 0.57 m and the aluminum angle has to be formed to match.

The process of building blade sections for the present invention is described below:
1. The lower shelf hubs 40 and spokes 45, consisting of aluminum arms, are arranged and coupling brackets (small angle brackets 46) are installed on each spoke 45.
2. With the small angle brackets 46 in place, each spoke 45 is attached to the centrally disposed hub 40 via longer coupling angle brackets 43.
3. When the bottom shelf assembly 20 is completed a turbine blade body 19 is aligned and holes are drilled for riveting 42 (which is repeated 2 more times).
4. Assembly of the top shelf assembly 22 is a mirror image process of the bottom shelf assembly 20 whereby both ends of the wind turbine assembly 10 are “capped” for better wind capture as well as increased stability.
5. The top shelf assembly 22 is aligned to the 3 turbine blade bodies 19 and holes are drilled for rivet 42 placement
6. With top shelf assembly 22 and bottom shelf assembly 20 fastened to the 3 turbine blade bodies, the completed blade section assembly 14 is then able to be arranged vertically via shelf stacking—one section atop the next—to form the fully configured wind turbine assembly 10 where sections 14a-14d are then adhered to one another

### Turbine Platforms

As illustrated in FIGS. 3, 4 7-9, supporting the entire aluminum/glass fiber composite rotor assembly that is the wind turbine assembly 10 is the, lower turbine cap plate and support platform 35. The lower turbine cap plate and support platform provides support for the wind turbine assembly 10 structure at its base 11b, rigidity and stability (both on the base 11b and atop 11a the wind turbine assembly 10 structure) and an air dam capability to keep the wind from exiting the turbine assembly structure 10, both above and below the cavity of the turbine, further potentiating the ability of the turbine to capture air for enhanced assembly propulsion. The platform itself is made of 3 cap plate sections 33 and an integration plate 34 where each of the two turbine platforms 32 and 34, reside on each end of the wind turbine assembly 10 with the lower turbine cap plate and support platform 35 being the strongest and heavier of the two.

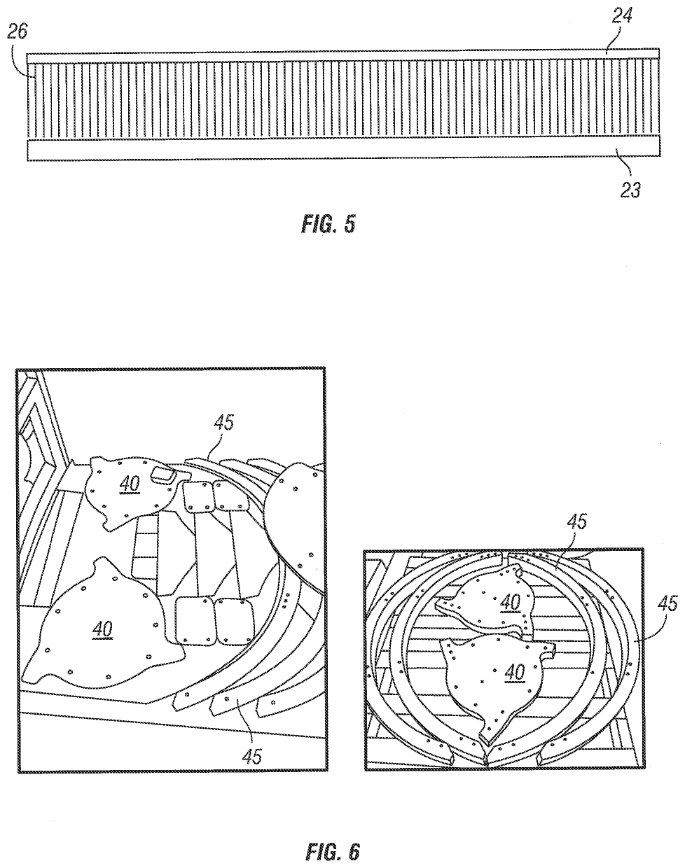

As shown in FIG. 5, both upper turbine cap plate 32 and lower turbine cap plate and support platform 35 are fabricated from a honeycomb polymer sheet 26 core with a fiberglass composite above 24 and below 28 sandwiching the honeycomb polymer sheet 26 (i.e. fiberglass-honeycomb-fiberglass). The top fiberglass sheet 24 is ⅛-inch in thickness and the bottom sheet 28 is ¼-inch thick. Adhesive is applied on the surfaces of the honeycomb polymer sheet 26 core to enhance bonding to two, pre-cut, glass fiber composite sheets 24, 28 on either side of the honeycomb polymer sheet 26 core and said fiberglass sheets 24 and 28 are aligned using steel dowels and trimmed in preparation for vacuum bagging, “Sandwich” panels are then vacuum bagged and allowed to cure overnight. Once cured, the panels are trimmed and prepared for edge finishing and painting. Edge finishing consists of covering the exposed polymer honeycomb polymer sheet 26 with resin and body filler for a smooth and ready-to-paint surface. Once the body filler is cured, each panel is sanded and painted.

### Turbine Blade 19 Fabrication

The wind turbine blades 19 (as shown in FIGS. 1, 2, 7-8) for the present invention are fabricated using fiberglass and epoxy utilizing a Vacuum Assisted Resin Transfer Method (VARTM). Each wind turbine blade 19 is made from a high temperature epoxy and fiberglass composite exhibiting a smooth surface for each wind turbine blade 19. The surface is treated with a chemical mold release agent to allow the epoxy/fiberglass part to be removed from the mold with minimal difficulty. Next, an engineered fiberglass fabric stack is laid upon the mold. The fiberglass fabric plies are cut oversize and the final cured wind turbine blade is trimmed to final dimensions to have a clean edge appearance. The fiberglass fabric is held in place with a spray adhesive that is epoxy compatible. The fiberglass stack is covered with a peel ply fabric that is porous to allow for air to be vacuumed out of the fabric and provides a flow path for the resin over the part. The peel ply also leaves a uniform finish when removed from the final part. Resin distribution channels, vacuum lines and resin infusion lines are attached to the blade and a non-permeable vacuum bag is attached to the mold with sealant tape. A vacuum pump removes all air from the inside of the bag. This “vacuum seal” provides compaction force as a result of the atmosphere pushing down on the outside of the bag. The final infusion step is to mix a two-part epoxy and to infuse the fiberglass. The pressure differential between the atmosphere and the vacuum forces the resin into the fiberglass on the tool. The part is left to cure at room temperature and then it is removed from the mold. The wind turbine blade 19 can now be trimmed to final dimensions and the tool is ready for another part.

### Power Transmission Shaft 50

As illustrated in FIGS. 10, 12 and 13, the power transmission shaft 50 is composed of 3 main components: the upper shaft 52, central shaft 54 and lower shaft 55. Breaking the power transmission shaft 50 into multiple components is necessary to allow installation of the bearings (i.e. cylindrical bearing 57 and TDO bearing 58). A tapered TDO (Two-Row Double-Outer Race) bearing 58 is used to support axial and transverse loading and is installed on the upper shaft 52. The upper shaft 52 must be heated to allow for an interference fit installation. The central shaft 54 ties the upper shaft 52 and lower shaft 55 together via two joining discs that are welded in place. The lower shaft 55 is the load path for the cylindrical bearing 57 and only supports transverse loading. The inner race of the cylindrical bearing 57 must be heated and pressed for an interference fit as well. A one-inch keyed shaft is installed through the center of the shaft and is coupled to the gear box. The turbine coupling plate 51 is positioned atop the power transmission shaft 50 where it is the point of direct contact between the power transmission shaft 50 and the wind turbine assembly 10. Further, the turbine coupling plate is supported by the upper shaft 52 which receives support from the union of the upper shaft 52 resting on the shaft collar 53.

Material for all shaft components is selected to be AISI 4140 alloy steel for its strength and machinability. Together with the bearings 57 and 58 the shaft weighs approximately 41 kgs.

### Primary Structure

An initial analysis was completed to determine the general and worst-case structural loads. At winds approaching 53 m/s (120 mph) the reactive load on the shaft bearing is around 142 KN (16 tons). Because of such high loads, structural steel is relied upon for the base components. The base component is a 0.66 m (26 in) diameter 2.54 cm (1 in) thick tube made from NISI 1026 steel with A36 steel bulkheads that are welded on. Total height of all weldments assemble together is 1.98 m (78 in) and weighs approximately 862 kg (1,900 lbs.).

### Weldments

The structure consists of 3 main weldments; lower, mid and upper weldments as shown in FIG. 19 from left to tight. The intent in breaking up the structure this way is to make the installation and handling less difficult. Such separation will also enable simpler parts repair and replacement. The upper weldment 60 supports the tapered bearing housing while the lower weldment supports the cylindrical bearing 57, brake 59, gearbox 70 and power generator 75 (as shown in FIG. 16).

### Power Transmission Shaft 50

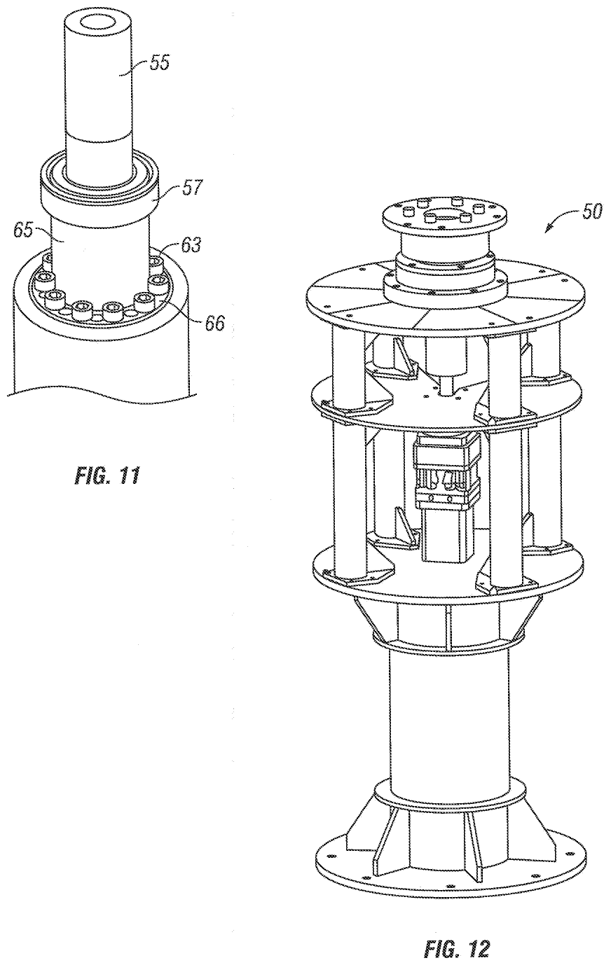

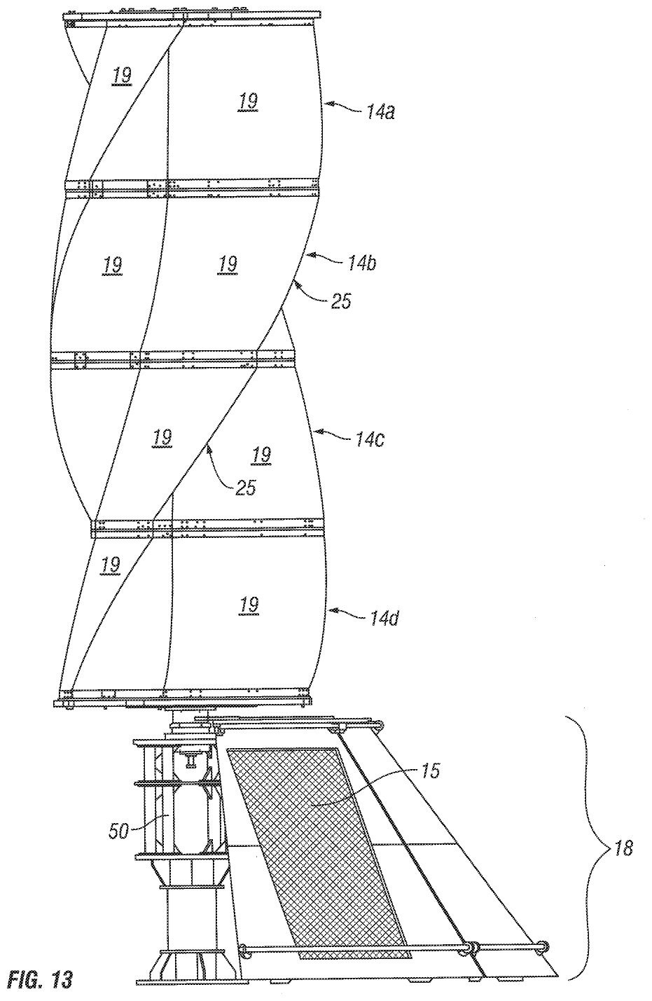

The locking assemblies used in the power transmission shaft 50 are mechanical devices which are keyless and self-centering allowing for stronger and well-balanced joints between the various power transmission shaft 50 components (see generally FIGS. 10 and 12). These assemblies eliminate the reliance on joining shaft members via welding or bolted joints. These assemblies thus also allow for relatively simple disassembly of the power transmission shaft 50 for maintenance or transport. As depicted in FIG. 11, there is a circular pattern of bolts 63 around each locking device 65. The number of bolts depends on the size of bore where larger bores necessitates increases in bolt 63 numbers. To loosen the locking device 65, bolts 63 are moved to ‘jacking holes’ which allow the mechanism to spread apart. Once the device is geometrically able to slide over and between the shaft components the bolts 63 are placed into the ‘locking holes’. The bolts 63 are then, gradually, torqued in a circular pattern until the specified torque for each bolt 63 is attained.

### TDO Bearing 58 Installation

Four machine-matched components make up the TDO bearing 58: two rows (i.e. cones), a high precision spacer that provides the exact manufacturer designed gap between rows and an outer cup. The cones, which contain rollers, are designed to have an interference fit with the central shaft 54 and are pressed on. First the lower cone is pressed on, the spacer is placed on the shoulder of the lower cone and the outer cup was placed over the assembly. Finally, the upper cone is pressed on to finish the TDO bearing 58 installation. The outer cup spins freely and is the direct link to the housing structure.

### Upper Shaft 52 and Collar Installation and Assembly

The shaft collar is threaded on until it is seated against the TDO bearing 58 upper cone shoulder (although other modes of attachment can be contemplated). With the upper locking device placed over the central shaft 54 and resting on the collar, the upper shaft 52 is slipped into position. Once in position the locking device is torqued 145 N-m (107 ft-lbs.) per bolt, and according to the specifications, as described above.

### Lower Shaft 55 Installation and Assembly

The lower shaft 55 is then placed between a locking device 66 and the central shaft 54 located at the bottom of the central shaft 54. Locating the lower shaft 55 must be precise where a scale is used to measure the shaft depth before torqueing the locking device 66. As described above, the same process for installing locking devices 66 is used, except for the final bolt torque of only 61 ft-lbs.

### Cylindrical Bearing 57

The cylindrical bearing 57 is made up of two components: an inner race and an outer roller bearing assembly. The inner race is pressed onto the lower shaft in a similar manner as the cones of the TDO bearing 58 (above).

### Turbine Brake 59

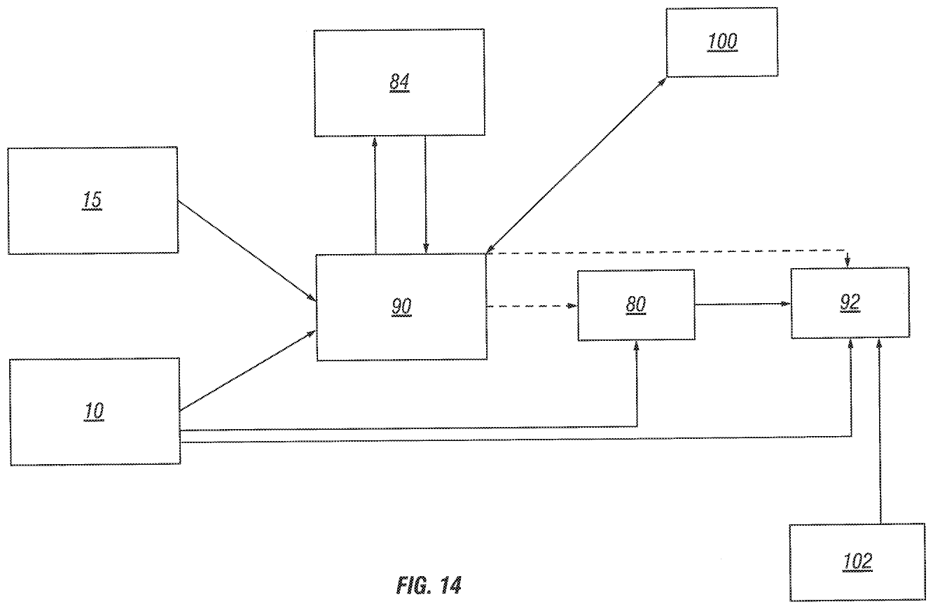

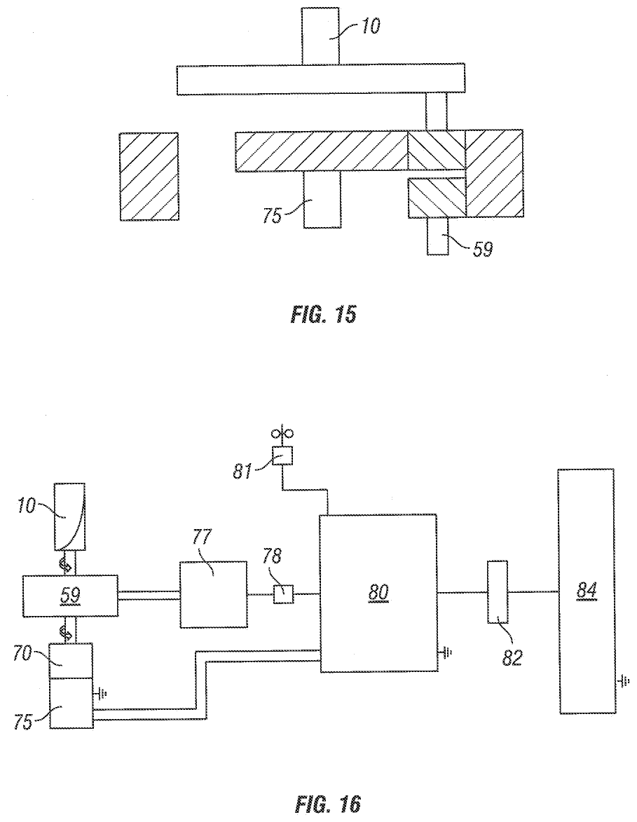

A Nexen® I300 brake is installed just below the cylindrical bearing 57 and operates on pneumatic pressure up to 600 Nm. The brake 59 may be spring engaged, and air released—which is the present design. The pressure range to overcome the springs is 4-7 bar (60-100 psi). A locking device 56 couples the power transmission shaft 50 to the brake 59. A simple pneumatic circuit is fabricated to control the rotation of the turbine to safely arrest the turbine rotation where the brake is designed to work in conjunction with a generator to arrest the rotation—braking initially through the control generator acting as a motor and then through the pneumatic brake for final parking. As can be seen in FIGS. 14, 15 and 16, wind energy received in wind turbine assembly 10 is transferred through gearbox 70 and to generator 75 after brake 59 is disengaged through release of pressure from pressure release at compressor 77 via switch 78. Wind power is then converted into mechanical energy that through the AMC drive 80 through charge controller 82 for eventual storage into the battery load bank 84.

### Prototype Turbine Construction

Ease of transport and assembly are two of the primary design considerations for the VAWT assembly invention 12 and the total structure is approximately 8 meters tall, including the base. With component modularity and maneuverability as the focus, the sequence of assembly is shown in these general steps:
1. Secure the primary structure to the ground.
2. Install the transmission shaft 50
3. Install the bottom platform assembly
4. Install blade assemblies 14a-14d
5. install the top platform assembly 10
6. Install equipment (i.e. brake 59, generator 75, gearbox 70 and controller 82)

### Final Assembly

Blade Sections are assembled into two section towers inside—to ensure a windless environment, the blade sections are assembled indoors. The lower platform is fastened to the bottom of a section and then a second section is lifted and fastened to the first. This was repeated for the remaining sections with the upper turbine cap plate 32 atop the structure.

Two tower sections are assembled where a lower blade section tower and upper blade section tower are assembled together outside. The two section towers are moved outside and staged for a crane to begin the final assembly process prior to placing the completed turbine 10 on the primary structure.

The full wind turbine assembly 10 is lifted to the top of the inwardly planning base 18 structure and mounted on the turbine coupling plate 51. With the blade sections fully assembled, the crane lifts the wind turbine assembly 10 into position (as depicted in FIGS. 12 and 13 where the rotationally operable shaft 50 can be seen alone in the former and integrated into the VAWT assembly invention 12 complete with photovoltaic panels 15 in the later) while personnel on the ground made fine adjustments to the shaft position (aligning the bolts 63 and torque is applied). A scissor-jack lift is used to access the top of the turbine (7.8 m/26 ft) and detach the crane from the turbine lifting bracket.

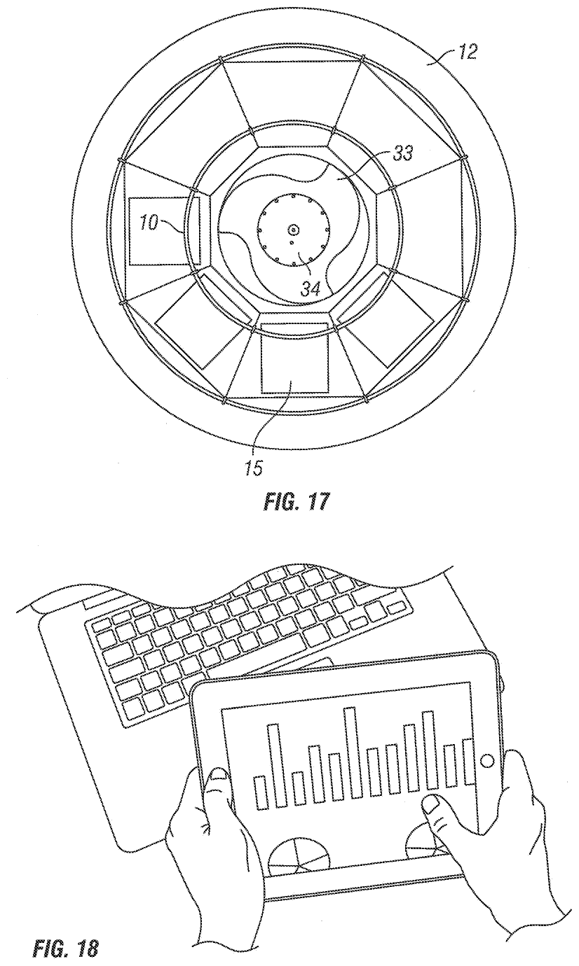

FIG. 17 is a fully assembled VAWT assembly invention 12 in a top view wherein the wind turbine assembly is centrally positioned and the photovoltaic panels 15 can be seen positioned about the inwardly planning base 18.

### Operation

### Generator 75 and Gearbox 70

Based on windspeeds between 5 m/s-10 mls an estimated 97-794 W are estimated. The generator 75 and gearbox 70 are sized to optimize generator efficiency at a power range above and to be large enough to provide dynamic braking. FIG. 16 shows the general geometry of the generator 75 and attached gearbox 70. The generator 75 installation is designed to accommodate different sizes can be tested to determine optimal performance.

### Controller (Drive) 80

As illustrated in FIG. 16, the control drive 80 will control the generator 75 through three (3) inputs: Velocity (RPM), current and position. The measured velocity will be used to control the torque and initiate dynamic braking when an overspeed event is detected. From the controller to the motor, there are 3 wires for power and 5 wires for a hall effect sensor. On the other side of the charge controller 82, there are two wires terminating at a DC power sink/source. This termination point is preferentially a set of batteries (e.g. 6×12 volt car batteries) to provide us approximately 80VDC but may be another termination point. A charge controller 82 is used to protect the batteries 84, directing power through a resistor and dissipating the power should the batteries 84 become overcharged.

Turbine RPM and torque will be transmitted via the rotationally operable transmission shaft 50 which integrates with a pneumatically powered brake 59 and a gear box 70. The latter allows the RPMs to step up while stepping down the torque. The AMC Drive 80 will monitor the generator 75 and determine if the wind turbine assembly 10 is within its design limits based on user input and programmable logic. If the specified limit power is reached the AMC drive 80 will begin to shut the generator 75 down slowing the wind turbine assembly 10. It will also control a switch 78 tied to the compressed air 77, engaging the brake 59 and fully parking the wind turbine assembly 10 once the power has been reduced to a specified level. An anemometer 81 provides data to the drive to correlate power and wind speed.

A charge controller 82 protects the battery bank 84 from overcharging. The battery bank 84 is used as the repository for generated electricity and provide power to the AMC drive 80, anemometer 81 and compressor 77.

### Photovoltaic (PV) Panels

The relationship between all functional parts of the assembly are represented diagrammatically as a circuit in FIG. 14 where the means to integrate and combine the photovoltaic energy generating photovoltaic cells into the wind capturing blade assembly are shown with photovoltaic panels 15 as well as wind turbine assembly 10 which act through inverter 90 to charge battery 84 to generate power that is supplied to AMC drive 80 Zedi-Field Gateway 92 weather station 102

Typically, photovoltaic panels 15 are fiat or curved and generally include a transparent protective cover over a photovoltaic array which converts solar energy into usable electrical power

### EXPERIMENTAL TESTING OF OPERATION

### Initial Testing and Equipment

Initial performance testing on the VAWT assembly invention 12 was performed outside under natural wind conditions. Data collected were wind speed and turbine revolutions per minute. The wind speed was measured with an anemometer with a 0 to 2 volt output, mounted approximately 3.7 m (12 ft) off the ground and 1.8 m (6 ft) from the turbine. The revolutions per minute of the rotating turbine were measured by a hall effect sensor set at the base of the rotationally operable turbine shaft 50. Signals were collected from both travelled through an analog data acquisition device and then fed into a laptop via a USB cable where the data was collected for analysis. Each data point was time-stamped.

This experimental setup is sufficient to gain top level insight into the basic operating characteristics of the VAWT assembly invention 12, but is in no way intended to fully describe the operational envelope and full operating capacity of the VAWT assembly invention 12. Error inherently exists for this rough data collection, including but not limited to building obstructions, turbulence, and single location anemometer readings. The site was not selected for good performance but was an initial setup to verify assembly and basic performance of this initial prototype. Future data collection efforts our ongoing for both scaled down wind tunnel testing, as well as more thorough real-world data collection to more fully characterize the VAWT assembly invention 12 performance. Information gathered is critical for complete optimization of the energy conversion system, including the gearbox, generator, and all electrical components.

The preliminary data recorded over a 24-hour duration on Mar. 7-8, 2018 was plotted to select valuable timeframes of information. One particularly interesting data set is included here for discussion, covering approximately 45 minutes beginning at 3:47 pm on March 8th. Based on this specific data set, effort was made to estimate an unloaded cut-in windspeed and to estimate the naturally driven tip speed ratio at which the turbine will rotate. This data is useful to confirm analytical predictions and to define expectations for real world prototype performance.

Windspeeds were recorded in Golden, Colo. at the time of interest. Shown in blue is the data collected form the anemometer located at the base of the turbine. For comparison, a plot of a local weather station's wind data across the same time interval is shown in orange. That weather station is located approximately ½ mile south-east of the site of the turbine, with data publicly available online at Weather Underground.

Again, substantial differences between the data are expected due to the obstructions and naturally variable ground level wind being detected. These two curves do show that independent anemometer readings across the same range of windspeeds at the time of data collection, with an average recorded wind speed at the turbine of just over 1.3 m/sec (3 mph) and a maximum recorded wind speed of around 4.5 m/sec (10 mph). Collected data is evidenced below:

### PREFERRED EMBODIMENTS

In one embodiment of the present invention, the hybrid solar and wind system of the present invention can provide a completely integratable “open source” energy via renewable energy sources that can be seamlessly integrated into existing power grids to provide primary, secondary as well as alternate power in a variety of settings that is scalable, flexible, urban-friendly (both auditory and visually), environmentally clean, and is utilized at the source of consumption (where individuals live and work).

Another preferred embodiment seeks to integrate solar photovoltaic technology onto the surface and/or into the vanes of a Vertical Axis Wind Turbine (VAWT) whereby the blades themselves become the means of photovoltaic collection.

It is yet another preferred embodiment envisioned by the inventors that the present invention could be directed and operated via two-way digital intelligence controls and software that could enhance the efficiencies of the present invention to further augment the invention's overall capacity to share and distribute energy more efficiently and effectively, while decreasing deficiencies of the presently used VAWTs both in terms of captured and transformed wind energy, harvested solar and thermal energy, or a combination of all of these energies.

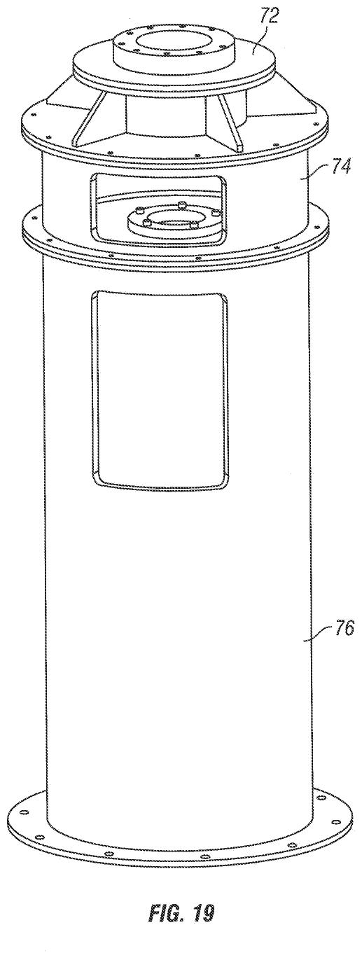

In another embodiment (as shown in FIG. 18) a smart system with dedicated software is used to operate and analyze the functions of the present invention with a “smart software” function that allows the user to monitor and control energy input, energy output, energy consumption and energy deployment to the grid thereby allowing the consumer of the derived power to self-assimilate power use and initiate and modulate power sell to existing grids and networks based on production, cost, and the real-time demands of the grid.

In another preferred embodiment, the present invention has the capability to deliver energy directly to the consumer at the point of power consumption (as opposed to reliance upon a distance power supplier and “community” distribution channels). This direct distribution would have the advantageous effects of both “smart-grid” (software enhanced) and “micro-grid” (individually and personally guided and adapted power use), decreased reliance upon established supply channels, and a “clean” renewable alternative to environmentally detrimental energy sources such as carbon-emitting “fossil fuels”.

It is yet another preferred embodiment that the present invention could provide “containerized”, movable and placeable self-contained and self-sustained energy generation units or “pods” that could easily operate independently of conventional power generating resources. Examples include, among other facilities, a mobile medical unit, a water processing plant or a telecom center in areas previous thought too remote and inaccessible.

It is another preferred embodiment where both the blades and upper and lower turbine platforms of the helical 3-blade Savonius-type vertical axis wind turbine (VAWT) would act as a receiver of photovoltaic energy by mounting and encapsulating photovoltaic cells on or about their surfaces.

In another embodiment, inventors can either contract to build and install the hybrid turbines that are the present invention, license a distributorship to others, or provide a “kit”, utilizing the technology herein, and method of manufacture for “self-assembly” and build or semi-autonomous assembly and build.

In another embodiment the hybrid solar/wind turbine that is the present invention can be used atop another structure (e.g. a cell phone tower, street light, building or structural rooftop) to provide tower power generation to facilitate or replace the conventional power supply (e.g. diesel generators) required for either full-time, continuous operation, intermittent stand-by operation or as a permanent primary power supply.

In another embodiment the present invention can be used for natural stationary sea bound areas (e.g. islands), where energy is expensive to procure, man-made stationary sea bound oil rigs and observation stations and lighthouses, where energy is difficult to generate, and moveable sea bound vessels (e.g. large ships and freight carriers) requiring great amounts of energy for operation—all having ample access to both wind and solar energy sources.

In yet another embodiment the present invention can be compatible with and integrated into a “smart home” that uses other “green features” such as, but not limited to, bioenergy, geothermal energy, additional solar energy, additional wind energy, hydroelectricity, energy efficient appliances, recycling, improved and maintainable air quality, environmentally preferable building material and design (“green engineering”), urban patterns of development, water efficiency, waste reduction, greenhouse gas reduction, “green” agriculture roofs, solar-paneled roofing and shingles, enhanced insulation, environmentally conscious landscaping, and the like.

We claim:

1. A hybrid solar/wind turbine apparatus comprising:
a blade and shelf assembly configured to provide wind impulsion and wind capture, the blade and shelf assembly being located between an upper and a lower platform assembly the blade assembly being helically disposed about an axis, for generating torque:
a transmission shaft in communication with the blade assembly and configured to receive the generated torque;
one or more photovoltaic cells in communication with the blade assembly for photovoltaic energy generation, either alone or in combination, with the torque; and
a means to integrate and combine the photovoltaic energy generating photovoltaic cells into the wind capturing blade assembly.

2. The apparatus, according to claim 1, in which the blade assembly includes three uniformly spaced apart blades located between two shelf assemblies and connected thereto.

3. The apparatus, according to claim 2, in which the three spaced apart blades are connected to a hub and a spoke configuration and stacked vertically.

4. The apparatus, according to claim 1, in which the blade assembly includes four stacked blade sections located between the two shelf assemblies.

5. The apparatus, according to claim 1, in which the blades are a curved blade body.

6. The apparatus, according to claim 3, in which each of curved blade body is a half S-shaped curve projecting outwardly from the hub; the curved blade bodies each being equally spaced apart about the hub.

7. The apparatus, according to claim 4, in which the blade assembly is mounted on a support platform.

8. The apparatus, according to claims 1 and 7, in which the photovoltaic cells are disposed in photovoltaic panels located about the support platform.

9. The apparatus, according to claim 8, in which the photovoltaic panels are disposed around an inwardly planning base to optimally capture solar energy.

10. The apparatus, according to claim 1, in which the means to integrate and combine the photovoltaic energy generating photovoltaic cells into the wind capturing blade assembly is a circuit, wherein the circuit includes the photovoltaic panels that are electrically connected to a battery via an inverter so as to charge the battery.

11. The apparatus, according to claim 10, in which the blade and shelf assembly are electrically connected to the battery via the inverter so as to charge the battery.

12. The apparatus, according to claims 10 and 11, in which the battery once charged is capable of powering an AMC drive and a Zedi-Field Gateway.

13. The apparatus, according to claim 12, in which a weather station is in communication with the Zedi-Field Gateway.

14. The apparatus, according to claim 10, in which a charge converter is connected to the battery to prevent the battery from overcharging.

15. The apparatus, according to claim 1, in which the rotationally operable transmission shaft includes an upper shall, a central shaft and a lower shaft.

16. The apparatus, according to claim 15, in which a turbine coupling plate is connected to the upper part of the transmission shaft and is further connected to the blade and shelf assembly.

17. The apparatus, according to claim 13, in which a locking device is located between the central shaft and the lower shall

18. The apparatus, according to claim 17, in which the locking device couples the transmission shaft to a turbine brake to control the rotation of the turbine.

19. The apparatus, according to claim 12, in which wind power generated by rotation of the transmission shaft is converted to mechanical energy through the AMC drive via a charge controller, the charge controller being connected to the battery.
